(19) United States
(12) Patent Application Publication
(10) Pub. No.: US 2023/0183882 A1
(43) Pub. Date: Jun. 15, 2023

(54) SOFT MASK TECHNOLOGY FOR ENGINE SURFACE TEXTURING

(71) Applicant: The George Washington University, Washington, DC (US)

(72) Inventors: Stephen M. HSU, Germantown, MD (US); Govindaiah PATAKAMURI, Ashburn, VA (US)

(21) Appl. No.: 17/924,907

(22) PCT Filed: May 12, 2021
(86) PCT No.: PCT/US2021/032018

§ 371 Date: Nov. 11, 2022

Related U.S. Application Data
(60) Provisional application No. 63/023,584, filed on May 12, 2020.

(51) Int. Cl. C25F 3/14; C25F 3/06

(52) U.S. Cl. CPC C25F 3/14; C25F 3/06

(57) ABSTRACT

A method of forming a surface texture includes arranging a flexible mask (610, 920) with a pattern over a surface (621) of a component (620); and performing electrochemical etching on the surface (621) of the component (620) to form a surface texture on the surface (621) according to the pattern of the flexible mask.

### SPONSORED RESEARCH

This invention was made in part with Government support under Contract No. EE0006870 awarded by DOE. The U.S. Government has certain rights in this invention.

### CROSS-REFERENCE TO RELATED APPLICATIONS

This application claims the benefit of priority of U.S. Application Ser. No. 63/023,584 filed on May 12, 2020, the content of which is relied upon and incorporated herein by reference in its entirety.

### FIELD

The disclosure relates generally to the field of engine surface texturing and more particularly to a method of forming surface pattern on a variety of materials such as ceramics, polymers, and metals.

### BACKGROUND

As climate change producing severe weather storms, the world is working hard to reduce carbon emission both in the short term and the long term. One of the ways is to dramatically increase fuel economy of cars and trucks and energy efficiency of machineries in the short term. There are many fuel efficient technologies being employed in new engine models, at the end, surface textures will add onto the fuel efficiency technologies to further improve fuel efficiency by eliminating most of the parasitic friction losses under sliding motions. Lubrication and friction control between moving engine components plays essential role in energy conservation. Surface textures are increasingly being used by engine manufacturers to reduce friction yet the cost is high. This primarily stems from high cost of fabricating discrete or continuous on hard and tough engine surfaces.

Fabrication of surface textures on engine surfaces is difficult and costly. Engine surfaces are hard, tough, and often have surface treatments, sophisticated coatings, organic and inorganic thin films protecting the surface. Laser surface texturing (laser ablation) has been used in experimental trials to fabricate micro-dimples on cold rolled steels. As engine design for enhanced fuel economy, increasingly more advanced materials are being introduced into engine components, many of them are in the form of coatings, and thin films. For instances, some coatings are multilayers sandwich consisting alternating thin layers of ceramics and metals, making them impossible for laser ablation. At the same time, the laser ablation process often produces surface pile-ups due to melting and rapid solidification, oftentimes requiring grinding and polishing to make the surface suitable for engine applications. If microcracks formed from the rapid cooling, they will cause low cycle fatigue issues, especially in engine applications.

Vibromechanical texturing method (Greco, A. et al., 2009, J. Manuf. Sci. Eng., 131, pp. 061005-1) was developed to texture on metal components. Controlled vibratory tool is used to cut micro sized dimples on to the surface of work piece. Vibromechanical texturing method has limitation in controlling size and geometrical shape for smaller dimples. Vibromechanical texturing method only good for soft metals. This vibromechanical texturing method is not feasible for engine components which made of hard and tough metals.

Flexible micro stencil (Choi, J. H. et al., 2011, Inter. J. Precis. Eng. Manuf., 12, pp. 165-168 and Chen, X. et al., 2015, Precis. Eng., 39, pp. 204-211.) fabricated by using SU8 master pattern on wafer surface. These flexible micro stencils were put on curved steel surface and performed electrochemical etching to create circular dimples. This micro stencil technology on steel surface only demonstrated for circular pattern. None of these inventions was demonstrated for texturing geometrical dimple shapes such as ellipse. Precision in geometrical shape and size is reported to be key future for friction reduction. None of these soft mask technologies reported to texture on complicated shaped engine components.

PDMS surface micromachining method (Chen, W. et al., 2012, Lab Chip.,12, pp. 391-395) using direct photolithography followed by reactive ion etching (RIE) were reported to create pattern holes. Photoresist pattern on PDMS film surface was achieved by conventional photolithographic process. Photoresist patterned PDMS surface was dry etched with reactive ions to create micromachined pattern holes. Etch rate of PDMS was optimized by controlling RIE power and reactive ion gas mixture. This invention used photoresist layer as mask for RIE micromachining of PDMS surface. Photoresist mask may be weaker to shield reactive ions. In the present modified the lithography process by adding patterned metal mask on PDMS film surface for RIE micromachining.

U.S. Pat. No. 5,284,554A describes the electrochemical micromachining of metal surface by means of through-hole processing. Through-hole nozzle plate with narrow openings for electrolyte flow was used as cathode mounted on encloser was placed on the work piece surface. In this case, the work piece acts as the anode. Electrolyte solution was pumped through nozzle plate holes while applying voltage to chemically etch and create pattern holes on work piece. However, size and shape control of dimple patterns is difficult on nozzle plate. This technique is limited to flat surfaces and difficult to apply for curved surfaces such as engine bearings.

U.S. Pat. No. 6,699,665 B1 describes the use of flexible elastomeric mask with openings for preparing micro bioarrays. The flexible elastomeric mask was fabricated by preparing a master mask on a smooth flat surface such as silicon wafer. The surface patterns are usually simple, lines with openings. A flexible soft mask with openings was generated when polymer film was peeled from master mask surface to form bioarrays (composed of proteins, nucleic acid, cells, enzymes, and other biological materials). The soft mask layer on substrate act as stencil to allow deposition of biomolecules onto substrate through mask openings onto the surface. When the mask was peeled off, the deposited biomaterials were left behind forming the bioarrays. This method is not capable to work on rough or high curvature or irregular surfaces made out of steel and bearing steel non-organic metallic surfaces.

U.S. Pat. No. 7,282.240 B1 discloses the fabrication process of flexible elastomeric mask with openings that can allows deposition of a variety of materials through mask openings. The flexible elastomeric mask with opening was fabricated by template method. The template was filled with polymer materials and polymer film after curing or drying was simply peeled from template to get patterned openings in flexible mask. In process the flexible mask effectively seals against substrate surface, allowing simple deposition of materials from fluid or gases phase through mask openings, and then flexible mask simply peeled from surface of the substrate to leave patterned materials behind.

U.S. Pat. No. 10,245,806 describes the friction reduction by texturing on engine components. The ‘806 patent is incorporated herein by reference in its entirety. In the ‘806 patent, the textured dimples on engine components were generated by using soft mask and electrochemical etch. This texturing process involves 2 step UV lithography process. In the first step flexible soft mask was fabricated by UV lithography. The pattern was replicated from hard mask onto flexible polymer surface in the first UV lithographic process. The photoresist pattern was then replicated onto engine component by using soft mask and a 2nd UV lithography process. The photoresist patterned engine component was electrochemically etched to create textured dimples. However, the photolithography process on curved engine components surfaces such as bearings, camshaft need extensive corrections to compensate the curvatures, in some cases, for highly concave surfaces, this process may not be feasible. This difficulty leads to our current invention to eliminate the second UV exposure by developing a-step process to transfer the design directly to the soft mask.

Surface texturing, including surface roughness, directionality of roughness, topography including discrete geometric shapes (circular dimples, shallow smooth grooves, V-shaped grooves, triangles, elliptical dimples, etc.) have proven to be useful in engineering applications to impart new functionalities. This area will grow across industries from biomedical devices to car and truck engines used in transportation.

One major obstacle to this surface technology is fabrication costs. The patterning of textural shapes, size, depth and pitch control in the vertical and horizontal directions, etc has to be precise, from nanometer to mm scales in the horizontal and vertical directions (3D topography control in order to expand the functionality). So the fabrication process is complex and precise, therefore costs are high. Yet the benefits are sometimes difficult to validate in application without resorting to expensive and time-consuming field tests.. Meanwhile, thousands technical papers on the subject are published every year, yet very few of them are being commercialized and put into practice.. One case in point, surface textures have shown to reduce friction in laboratory bench tests and some simple small engine tests, but not in modern production engines equipped with fuel efficient technologies used in new model cars and trucks, even though automotive engines are mandated to increase fuel economy So the surface texture technology has NOT been validated to be effective and capable of commercialization for use. This is one aspect that hinders the development of surface texture technology. The other main barrier is the cost of fabrication of surface textures on current modern engine with microscale precision is too high. This lack of benefit validation and the high cost of fabrication fundamentally has become the crucial barrier to the use of surface texture technology. This invention disclosure can overcome these two barriers.

### SUMMARY

The present disclosure provides a fabrication process that dramatically lower the cost of fabrication of complex surface pattern (including various geometric shapes, including circles, triangles, ellipses, rectangles, grooves, any shape that can be generated on computer graphics) on materials (metals, ceramics, polymers). The process starts in a nanofabrication facility using CMOS process to surface machine the silicon wafer to duplicate the textural pattern and surface machine the silicon to provide a positive image of the pattern. Polymer is then spin coated the positive features up to 70-90% of the heights. After curing, the polymer film is lifted off the silicon wafer (now the master patterner), forming a negative image of the surface pattern. This soft mask is then put on the engine surface for electrochemical etching. The master silicon wafer can be used to make many identical soft masks for applications. This process provides high fidelity and repeatable surface textural features.

### BRIEF DESCRIPTION OF THE FIGURES

FIG. 1 illustrates an example method for fabricating a flexible soft mask consistent with the disclosure.

FIG. 2 illustrates an example hard mask with a pattern consistent with the disclosure.

FIG. 3 illustrates an example Ag pattern consistent with the disclosure.

FIG. 4 illustrates an optical image of an example patterned soft mask consistent with the disclosure.

FIG. 5 illustrates a scanning electron microscope image of an example patterned soft mask consistent with the disclosure.

FIG. 6 illustrates an example electrochemical etching process using an example flexible soft mask consistent with the disclosure.

FIG. 7 illustrates an image of textured bearing steel surface after electrochemical etching showing circular dimples consistent with the disclosure.

FIG. 8 shows the dual white light interferometric microscope scanning data across the circular dimples on the textured bearing steel surface, showing the depth profiles of the dimples of FIG. 7 consistent with the disclosure.

FIG. 9 illustrates another example method for fabricating a flexible soft mask consistent with the disclosure.

FIG. 10 illustrates a positive feature 3-dimensional (3D) image of a master plate consistent with the disclosure.

FIG. 11 illustrates a textured dimpled surface of ellipse and circular dimple on a bearing steel test sample produced by soft mask made from the positive master mold shown in FIG. 10.

FIG. 12 illustrates an example soft mask transfer jig for concave bearing surface texturing consistent with the disclosure.

FIG. 13 illustrates an example fabricated texture on the elevated ridges of a pretextured concave bearing surface using soft mask consistent with the disclosure.

FIG. 14 illustrates example textured dimples on the contact area of a piston ring consistent with the disclosure.

FIG. 15 shows coefficient of friction (COF) of textured piston ring in comparison with COF of untextured piston ring at various loads using a ring-liner test rig.

FIG. 16 illustrates the data from the engine dynamometer test result showing textured engine parts produced higher torque under fired wide open throttle from various speeds from 1400 to 1800 rmp.

FIG. 17 shows the torque changes due to the surface textures for the speed range of 1100 rpm to 5500 rpm.

FIG. 18 shows textured rod bearing before and after engine test.

### DETAILED DESCRIPTION

In describing the illustrative, non-limiting embodiments of the disclosure illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments of the disclosure are described for illustrative purposes, it being understood that the disclosure may be embodied in other forms not specifically shown in the drawings.

The present disclosure provides a technique directed towards addressing the above-described issues. And the motored engine tests showed improvement in engine efficiency of about 3% under firing conditions and 5.5% under 100% motoring with external power to move the engine parts. The firing conditions reduce the power gain due to additional resistance.

The present disclosure relates to the development of flexible soft mask with submicron to micron-scale variable dimple openings to couple with electrochemical etching to fabricate reduce friction, control heat transfer, control contact pressure, and/or creating a platform for surface engineering to enable multifunctional surfaces. Specifically, the present disclosure includes friction reduction in engines (automotive and heavy-duty diesel engines) to improve fuel economy and enhance durability. In one example embodiment, the surface pattern of U.S. Pat. No. 10,245,806 is applied to a component or part, such as an engine component, by the processes and devices of the present disclosure.

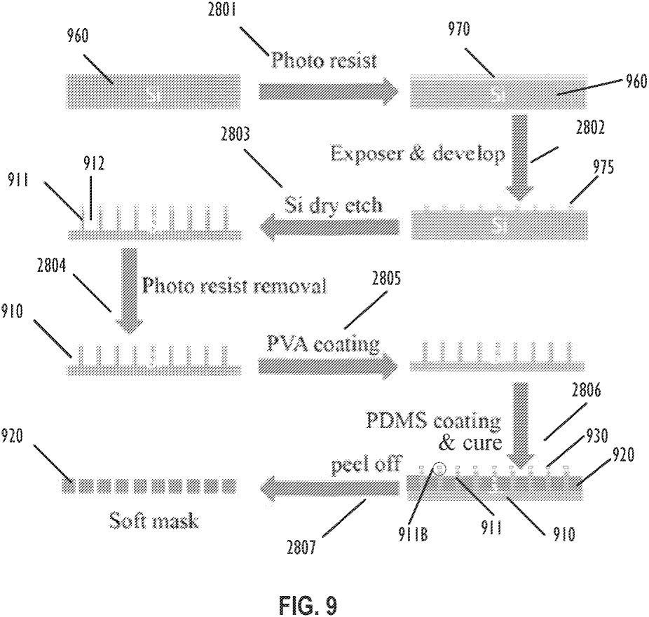

The present disclosure provides exemplary 1-step processes associated with the soft mask (e.g., flexible mask). In an example process used in fabricating the engine components for testing in the engine tests, reactive ion etching (RIE) dry etch on the soft mask is used to duplicate the surface textural features without the 2^{nd} Ultraviolet (UV) exposure. Due to the use of high energy ions to etch out the pattern, the precision of the shape control is about 3-5 microns. In another example, the present disclosure provides an improved 1-step soft mask fabrication (only 1 uv exposure step) by using surface machining to remove the silicon materials around each textural features, creating positive features of the surface dimples (instead of creating holes (negative image) (so on the silicon wafer, you have various pillars in the shape of circles, ellipse, etc.). This creates a master plate of the surface texture design. This master plate is then used to make soft mask if it is spin coated with polymer, and peeling off the soft mask from the master plate with one micron or lower shape control. This process is shown in FIGS. 9, 10, 11. For durability purpose, we deposited a thin layer of metal (gold, silver, chromium) on the master plate for repeated use.

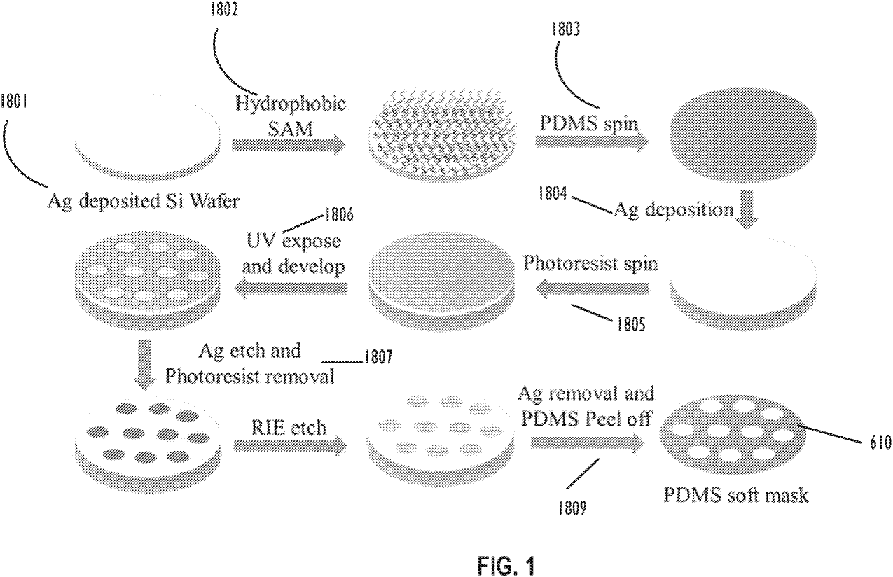

One aspect of the present disclosure provides a method for fabrication of flexible soft masks that have micron size opening holes with determined shape and size. The overall schematic diagram on flexible soft mask fabrication is shown in FIG. 1, which shows a soft mask based on a negative image (i.e., holes on the silicon wafer) of the textural pattern, then a dry etch process (plasma cutting) is used to burn holes on the soft mask. So, the soft mask can be used directly on the engine part surface. However, each soft mask has to be dry etched individually, so the mask pattern can potentially differ slightly. And, by cutting holes into the polymeric mask, the shape (e.g., elliptical shape angle) might not be sharp, which can affect the effectiveness of the elliptical dimples.

In one embodiment, the present disclosure includes the following steps (a) to (h). At step (a), Silicon (Si) wafer is immersed in 5:1:1 distilled (or deionized DI) water: NH₃OH: H₂O for 10 minutes at 75° C., then rinsed with DI water, to clean the surface and make the surface uniform before acid cleaning. After alkaline rinse, the wafer is rapidly immersed in 5:1:1 DI water: HCl: H₂O, then rinsed in DI water. After that, the wafer is immersed in 2% hydrofluoric acid (HF) solution for 10 seconds then is rinsed with DI water and dried. A 120 nm thick Ag film is deposited on cleaned and dried silicon wafer surface using E-beam evaporator (1801 of FIG. 1). After Ag film deposition, the wafer is immersed in 1molar 1-dodecanethiol solution in ethanol for 24 h at room temperature, then washed with fresh ethanol and dried for the fabrication of a self-assembled long chain organic molecules (self-assembled monolayer, SAM) on the wafer surface (1802 of FIG. 1). The long chain organic molecules have an end sticking on the silver surface and a tail being repulsive towards a polydimethylsiloxane (PDMS) film that is further formed over the long chain organic molecules, such that a soft mask further formed using the PDMS film can be peeled off without tearing.

At step (b), thin polymer film (1-10 µm) formation on silicon wafer surface is performed by spinning polydimethylsiloxane (PDMS) prepolymer (1803 of FIG. 1): curing agent (10:1, wt/wt) and heating at 80° C. in oven for 2 hours. The PDMS prepolymer can be, for example, monomer of PDMS. Film thickness depends on spinning speed and time. For 3-4 µm film thickness the spinning speed was optimized at 3500 rpm for 180 seconds without solvent dilution. Film thickness also depends on dilution of PDMS pre-polymer in solvents. In some examples, the curing agent may be a polymerization catalyst to cause the monomer to polymerize to form polymer (PDMS).

At step (c), a 100 nm thick or less silver (Ag) layer is deposited on the polymeric film (PDMS film) by using E-beam evaporator at 9.0×10⁻⁷ torr and 2 Å/second (1804 of FIG. 1). The silver (Ag) layer may maintain shape and strength of the polymeric film, and accordingly reduce or prevent shrink and wrinkle of the polymeric film.

At step (d), Photoresist (S1813) film (1-2 µm) is spin coated on surface of silver (Ag) layer by adjusting spinning speed and time, then baked at 100° C. for 2 min (1805 of FIG. 1).

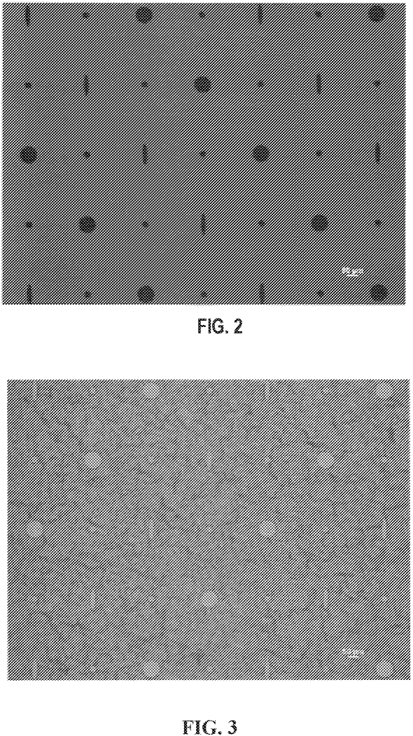

At step (e), the baked wafer is exposed to UV light (at dose 150 mJ/cm²) by using hard mask with designed pattern (such as a pattern with holes created by surface machining) and developed in Microdeposit MF 319 for 60 seconds to generate photoresist pattern (1806 of FIG. 1). Exposer dose depends on photoresist film thickness. Hard mask with chrome pattern used in this work is fabricated by using laser writer. The pattern on hard mask is shown in FIG. 2.

At step (f), the Ag layer with the photoresist pattern thereon is immersed in silver (Ag) etchant solution for 10-20 seconds for making Ag pattern on PDMS layer surface (1807 of FIG. 1). The Ag pattern after etching is shown in FIG. 3.

At step (g), the PDMS under the patterned silver layer (metal mask) is dry-etched using reactive ion etching process (RIE etching) with O₂ and sulfur hexafluoride (SF₆) mixture to create patterned micro-sized holes in the PDMS polymer mask (1808 of FIG. 1). The Etch rate of polymer depends on the reactive ion power, chamber pressure, and gas mixture. For example, etch rate may be be 0.4 µm/min. with gas SF6 (90 sccm, standard cubic cm per minute) and O₂ (6 sccm) at RIE power 300 W. During RIE etch, the patterned Ag layer on polymer surface works as a metal mask.

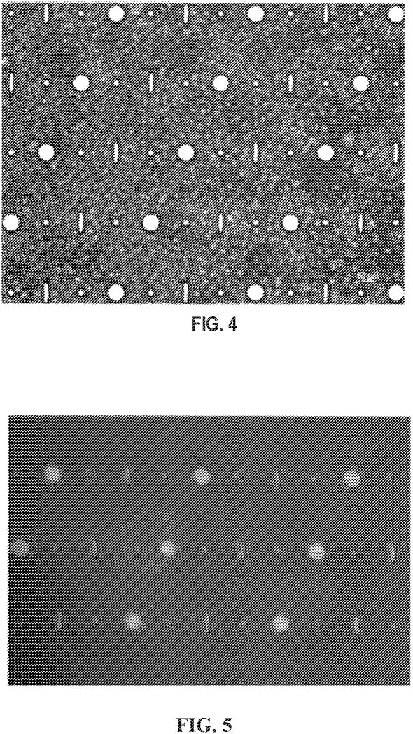

At step (h), after RIE etch of step (g), the patterned Ag layer and the Ag layer between the PDMS soft mask and the Si wafer are removed or dissolved by washing with 1 M nitric acid solution and PDMS soft mask (e.g., 610) with textural features (holes or other shapes) is peeled off from the silicon wafer surface, forming a soft mask, e.g., 610 (1809 of FIG. 1). The patterned soft mask 610 is shown in optical image in FIG. 4 and scanning electron microscope (SEM) image in FIG. 5. This is the finished soft mask ready for use to fabricate patterns on rough, irregular, curved engine part surface.

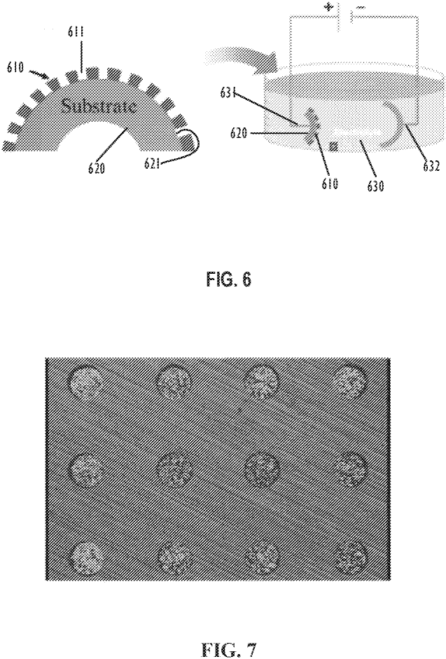

In another aspect of this disclosure, a soft mask is put or arranged on the engine part surface and electrochemical etching is conducted or performed with the soft mask. FIG. 6 illustrates the electrochemical etching process using an example flexible soft mask. In the example of FIG. 6, the soft mask 610 with holes 611 is glued on the curved surface 621 of the engine part or component 620 such as a convex bearing surface and immersed in the electrochemical bath 630, and turn on the current. The etching process is rapid ranging from several seconds to 10-30 seconds depending on the substrate material.

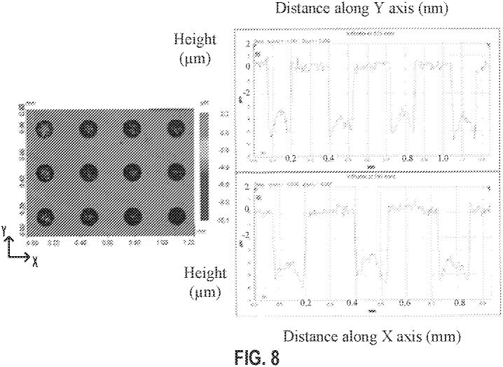

This surface texture fabrication process can be applied to, e.g., steel, 52100 bearing steel, ceramics and various coatings covering the engine parts. The engine part 620 with the soft mask 610 having circular dimple pattern is mounted on the cathode 631 and placed apposite to the anode 632. The electrochemical bath 630 is filled with 1 M FeCl3 solution. Voltage is applied to etch the steel sample 620 covered by the soft mask 610 according to the circular dimple pattern of the soft mask 610. The etching rate is optimized to be 0.3 µm/second at 2 volts in 1 M FeCl3 solution. After the etching step, the soft mask 610 is peeled-off and the now textured sample is washed with DI water. The fabricated sample image of a bearing steel surface is shown in FIG. 7. As shown in FIG. 8, the depth of the circular dimples fabricated on the bearing steel surface is about 5 µm deep for 15 seconds of etching time. The depth of the texture can be controlled by a combination of voltage, etching concentration and buffers, and the time of etching.

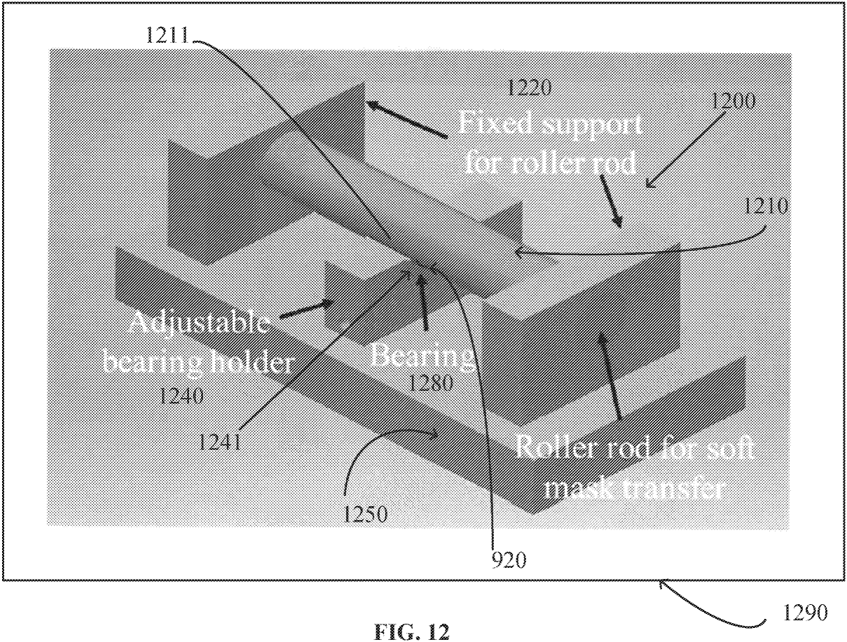

FIG. 9 shows another aspect of the present disclosure, as an alternative technique to producing a soft mask to that shown in FIG. 1. The masks of FIG. 1 and/or 9 are then used to form a pattern on a target surface, such as an engine component, as in FIGS. 6, 12. In FIG. 9, the 1-step texture fabrication can be further improved by replacing the dry etching of the polymeric mask with a modified complementary-metal-oxide-semiconductor (CMOS) procedure. When the textural pattern is transferred to the silicon wafer, instead of continuing to duplicate the holes and features (negative image of the pattern), the silicon can be machined away from the surface features (positive image of the pattern). This route is less frequently chosen for the much longer machining time and the mechanical stability of the pillars left standing. The overall schematic diagram of this process is shown in FIG. 9.

The process of FIG. 9 includes the following steps. At step (2a), Si wafer 960 is immersed in 5:1:1 DI water: NH3OH: H2O for 10 minutes at 75° C., then rinsed with DI water. After alkaline rinse, the wafer is rapidly Immersed in 5:1:1 DI water: HC1: H2O, then rinsed in DI water. After that, the wafers is immersed in 2% HF solution for 10 seconds then rinse with DI water and dried with a Semitool PSC-101 spin rinse dryer. (2b) Photoresist (ma-N 1410) film 970 is spin coated (1-2 µm) on surface of Si wafer 960 by adjusting spinning speed at 3500 rpm (see 2801 of FIG. 9), and then baked at 115° C. for 90 seconds.

At step (2c), the baked wafer of step (2b) is exposed to UV light at dose 150 mJ/cm² by using a designed patterned-hard mask and developed for 60 seconds to generate the photoresist pattern 975 (see 2802). The UV exposer and develop time is optimized for minimizing deviation in size and shape of the pattern copied from hard mask. The photoresist pattern after developing creates around 1-2 µm positive posts on the wafer surface, which serve as a position marking for inductively-coupled-plasma (ICP) dry etch to continue to machine or etch the surrounding areas to create tall silicon posts, for forming a positive master pattern.

At step (2d), the photoresist patterned wafer of step (2c) is baked in oven at 100° C. for 30 minutes.

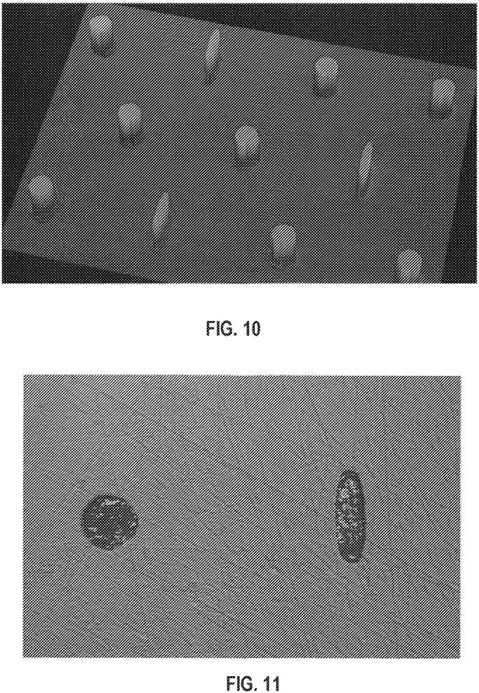

At step (2e), the photoresist patterned wafer from step (2d) is dry etched (ICP deep Si etch) with SF6 to create patterned micro columns 911 with various heights and trenches 912 between and adjacent one or more respective columns 911 (see 2803). Etch rate of Si depends on the power, chamber pressure, gas, and pattern size. The Si wafer with dry etched Si pattern columns 911 can be used as a master blue-print fabricator for fabricating soft mask. After the dry etch process, the photoresist layer on the top of the column is removed by immersion in acetone (see 2804). A 3-dimensional (3D) image of master plate 910 with column height 20 microns is shown in FIG. 10. In the example of FIG. 10, the micro columns of master plate 910 have elliptical shapes and circular shapes.

At step (2f), the master blue-print fabricator (MBF) 910 with positive features from step (2e) is dip-coated with 0.5 wt% polyvinyl alcohol (PVA) solution (see 2805). The hydrophilic polymeric thin film of PVA serves as a barrier coating (e.g., a non-stick barrier coating) to reduce adhesion between Si MBF 910 and the PDMS film which is deposited next, such that, when removing a soft mask 920 formed by the PDMS film from the Si MBF 910, a soft mask 920 can be safely removed from the Si MBF 910, and accordingly the micro columns 911 (e.g., pillar) of the Si MBF 910 are not torn off.

At step (2 g), PDMS prepolymer: curing agent (10:1, wt:wt) is filled into master mold coated with the hydrophilic polymeric thin film of PVA by spinning (e.g., spin coating) at 2500 rpm for 120 seconds to cast a polymeric film (4-5 µm) and then curing at an elevated temperature of 80° C. for 2 hours (see 2806), to form a soft mask 920. Film thickness depends on spinning speed and time. For 4-5 µm film thickness, the spinning speed may be optimized at 2500 rpm and for 120 seconds.

The pattern column heights of the micro columns 911 are high enough to achieve the soft mask 920 with fully open shapes when peeled off from the MBF 910, while, with such pattern column heights, the micro columns 911 are not pulled off when peeling off the soft mask 920. In some examples, the column height of the micro column 911 has a value in a range of 6 µm to 30 µm. The positive image of the textural patterns is coated with a chromium thin film tostabilize the surface. In some examples, the micro columns (or pillars) 911 and the silicon surface of the Si MBF 910 are coated with chromium thin layer before coating the hydrophilic polymeric thin film of PVA and coating the PDMS film thereon, such that the structural stability of the Si MBF 910 is maintained and the micro columns (or pillars) 911 do not break under repeated peeling off of the PDMS film. The chromium thin layer may reinforce the pillar strength, and may prevent or reduce rough and contaminated surface due to the reaction between the silicon and water. Experiments conducted with repeated peeling off the soft mask off the MBF showed no damage and the textural pattern remained the same. With the MBF being created, soft mask 920 can be made by simply casting the polymeric film and then peel off or lift off the soft mask (2807). This is a major advance in the arts and sciences of soft mask fabrication.

In some examples, the MBF 910 may be coated with the hydrophilic thin film to reduce adhesion between the MBF 910 and the PDMS soft mask 920, such that the micro columns 911 (e.g., micro pillars) will not cause the mask to rip or damage when the soft mask 920 is peeled off. In some case, an adhesion layer 930 (e.g., olephobic layer) may be deposited on the top of the columns 911, e.g., on, around, or surround the top portions 911B of the columns 911.

FIG. 11 illustrates the dimple pattern size and shape on a bearing steel test sample made with the soft mask using this new process.

In another embodiment of the present disclosure, the soft mask may be arranged or put onto the engine component surfaces, such as bearings for electrochemical etching. The transfer process of arranging or putting the soft mask onto a concave bearing surface, for instance, is not trivial. It is desired that the soft mask has direct conformal contact without wrinkling and tiny air bubbles. To facilitate accomplishing this task in a manufacturing setting, a specially designed transfer jig (e.g., a transfer apparatus) is used to put the soft mask onto the concave engine bearing surface (this concept works for other engine components, such as rings, cam lobe, and piston pins, etc.). Several conformal contact jigs can be made to ensure the conformity of the mask and the intended sample surface to eliminate air bubbles, tears, wrinkles.

Transferring a thin soft mask onto complex shaped engine components such as highly concave bearing is challenging. The soft mask may be 2-4 µm thick and easily wrinkled. The soft mask when peeled off the silicon wafer may be stretched under tension. When the mask is transferred to fit onto a concave bearing surface, it usually shrinks from the release of the tension. To solve this difficulty, as an example, a conformal jig is custom-designed and constructed to facilitate the mask transfer.

The mask transfer jig 1200 is shown in FIG. 12. A soft mask (such as 920 of FIG. 9 or 610 of FIG. 1) is carefully put or arranged on or over a roller surface 1211 of a roller 1210 of the transfer jig 1200. Then the roller 1210 is mounted on one or more fixed support member 1220 of the transfer jig 1200 as shown. The soft mask 920 is put or arranged on or over the roller surface 1211 in conformally to the bearing surface to avoid wrinkles or air pockets before it is transferred to a bearing surface. Then a bearing 1280 is mounted on a height-adjustable bearing holder 1240 and the bearing 1280 is slowly lifted to be close to the soft mask on the roller 1210 by adjusting the height-adjustable bearing holder 1240, and then the soft mask 920 is carefully placed onto the bearing surface of the bearing 1280. Further, the jig 1200 may be placed in a housing 1290; and with a close distance between the bearing 1280 and the soft mask 920 on the roller 1210 configured by using the height-adjustable bearing holder 1240, a vacuum may be created in the housing 1290, so as to transfer the soft mask from the roller 1210 to the bearing 1280. The close distance between the bearing 1280 and the soft mask on the roller 1210 configured for the soft-mask transfer by vacuum may have, for example, a value in a range of 1 mm to 2 mm or other suitable values chosen according to application scenarios. In addition, the vacuum removes air bubbles between the soft mask 920 and the bearing 1280. The height-adjustable bearing holder 1240 and the support members 1220 may be over or on a base 1250. In some examples, the roller surface 1211 of a roller 1210 may be shaped and sized to match with the bearing surface of the bearing 1280 and the bearing holder 1240 may have a concave portion 1241 to match with and hold the bearing 1280. In some examples, the roller 1210 may have a cylindrical shape.

In some examples, the roller surface 1211 of the roller 1210 may be coated with a hydrophilic polymeric thin film of PVA, by, e.g., dip-coating in 0.5 wt% PVA solution. The hydrophilic polymeric thin film of PVA serves as a barrier coating to reduce adhesion between the roller surface 1211 and the soft mask arranged over the roller surface 1211 (for, e.g., non-stick purposes), such that the soft mask can be removed or detached from the roller surface 1211 when transferring the soft mask from the roller surface 1211 to the bearing surface of the bearing 1280.

In some examples, the bearing 1210 has a corrugated grooved textures along a sliding direction. In order to reduce friction, the texture has to be fabricated on the elevated plateau rather than the valleys. So precise alignment at the submicron level is required.

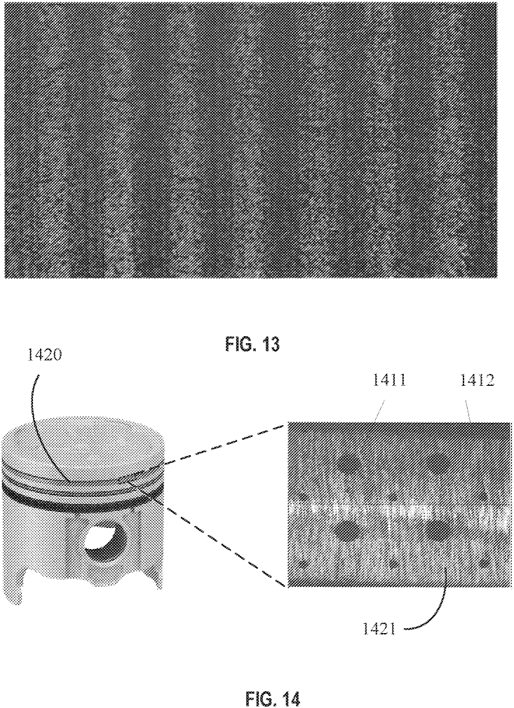

Alignment of the soft mask on the bearing surface with the dimples precisely aligned on the ridge plateau of the micro-textured bearing surface with micron precision is a challenge. Visible markers are made on the soft mask to align with the bearing 1280 mounted in the transfer jig 1200. The transfer jig 1200 is also marked. The three pieces are carefully assembled and adjusted, and the soft mask is transferred. FIG. 13 shows an example fabricated texture on the bearing 1280.

Another aspect of the present disclosure is the fabrication of surface texture on whole production engine components surfaces. Fabrication of surface textures on production engine surfaces is difficult and major challenge. The advanced engine surfaces are hard, tough, and often have sophisticated coatings and thin films deposited. Separate strategies may be needed for generating texture on engine components as each engine component made with different material compositions.

The adhesion and sealing between flexible soft mask and engine component surface control the deviation of the dimple shape from original design. Better sealing can prevent side corrosion/etch to control dimple shape. Static charge between mask and engine component surfaces generated by self-assembled monolayers can control the sealing/adhesion. Another aspect of sealing is use of adhesive layer between soft mask and substrate surface.

Selection of electrolyte composition plays major role on controlling dimple shape and depth. Selection of the electrolyte is based on materials composition of engine component. Optimization of mixed buffer may be needed for minimizing side etch on engine component.

In the electrochemical etching, voltage may be optimized to minimize side etch and control depth of dimples on engine component.

Etch time can be decided based on desired depth of dimple controlled by adjusting electrolyte composition, concentration, and voltage for particular engine component.

The distance between engine component (cathode) and anode in the electrolyte batch also one of the parameters to control etch rate.

In examples, a surface texture is generated on piston ring surface by using a soft mask and electrochemical etch. The soft mask with mixed circles openings of 25 µm and 80 µm is peel-off from wafer surface is transferred onto the whole piston ring surface.

The piston ring is electrochemically etched in equal amount of 0.2 M HCl + 0.2 M HNO₃ mixed solution. The etching rate is optimized or configured to be 0.1 µm/second at 10 volts. After the etching step the soft mask is peeled-off and textured piston ring is washed with DI water. The depth of the dimples created on piston ring is around 10 µm. The textured dimples 1411, 1412 are created on a surface 1421 of piston ring 1420 as shown in FIG. 14.

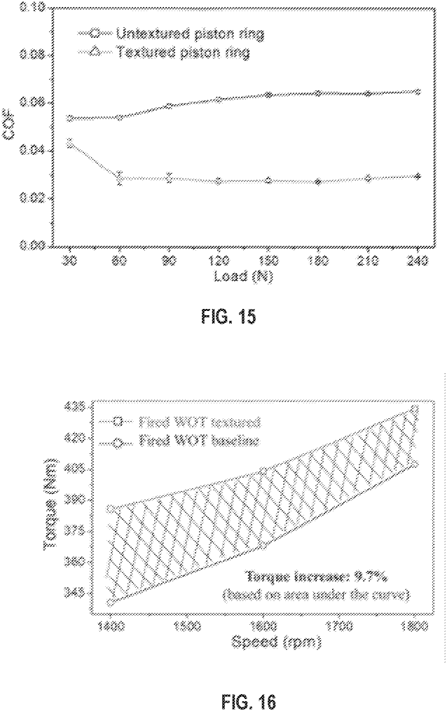

Another aspect of the present disclosure is validation of surface texture on simulated bench test. The friction tests are conducted on the Plint ring and liner simulator using production ring and cylinder liner segments at 100° C. with step loading procedure. The effectiveness of the texture is measured using a Plint TE77 ring-liner simulator with 0W20 commercial oil. Mixed circles pattern with size 25 µm and 80 µm on production piston ring (FIG. 15) is used for bench test. The frequency is fixed at 24 Hz by varying the load from 30N to 240N. The friction coefficient, i.e., coefficient of friction (COF) of textured piston ring is compared with the untextured piston rings, showing that the textured piston ring had a much lower coefficient of friction than the untextured piston ring at similar test conditions. The above test results show that the surface texture fabricated by using flexible soft mask is equal or better than results fabricated on flat surfaces such as silicon wafer.

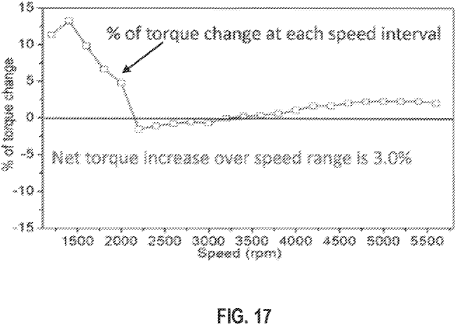

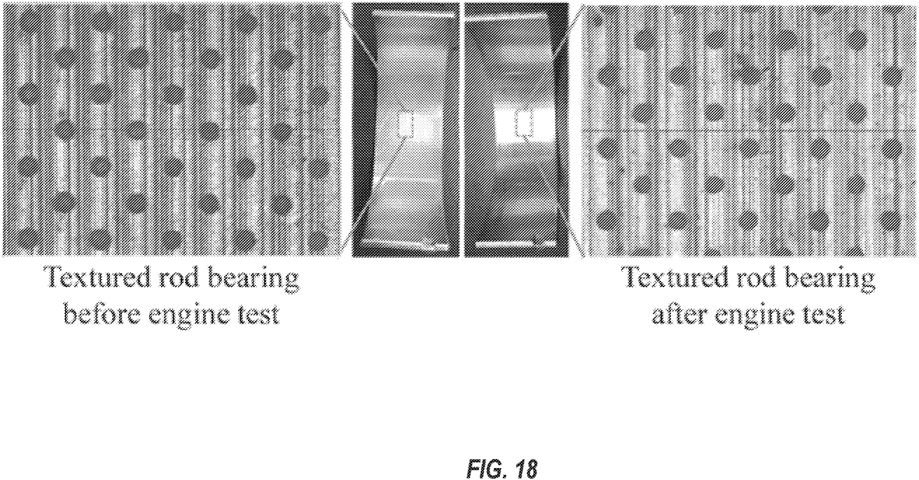

FIG. 16 illustrate the data from the engine dynamometer test result showing textured engine parts produced higher torque under fired wide open throttle from various speeds from 1400 to 1800 rmp. FIG. 17 shows the torque changes due to the surface textures for the speed range of 1100 rpm to 5500 rpm. The effect of textured engine components was measured in an engine dynamometer which was programmed to increase power as a function of speed. The torque measured was compared with a baseline. As shown in FIG. 17, the surface textures increase the torque for the speed from 1100 rpm to 5500 rpm, with the maximum torque increase for the speed in range from 1100 rpm to 2200 rpm, then the torque increase is reduced to zero increase at around 3200 rpm. The torque begins to increase after that and gradually rises to 3-4% towards 5500 rpm. The torque increases due to lower friction from the surface textures. FIG. 18 shows textured rod bearing before and after engine test, demonstrate the effect of engine running throughout the testing period (cumulative time of all testing, including the fuel economy tests). As shown in FIG. 18, the surface textures stay intact without any evidence of wear and damage to the surface textures.

The above fabricated soft mask with micro opening holes is not limited for surface texturing and also can be used for patterning of any suitable materials on any suitable kind of surface by putting or arranging mask and material deposition. The flexible soft mask consistent with the present disclosure can also be used for filtration applications.

Using the once through soft mask method consistent with the present disclosure, complex multiple surface features can be transferred onto steels, bearing steels, ceramics, advanced coatings, polymers materials, etc. under controlled size, shape, and depth in an simplified one-step process. Accordingly, for manufacturing repeated parts, the additional cost per part can be significantly reduced similar to the MEMS device manufacturing.

This process of the present disclosure is repeatable to produce identical surface patterns and maintain high fidelity of images of the geometric shapes such as elliptical angles and edges, thereby reducing the batch-to-batch variations and quality control issues.

The process may start with a surface design on the computer. Based on the speed, load, surface roughness, hardness, and temperatures, a surface pattern is designed for the part, and the pattern is produced on a silicon wafer in an inverted image, i.e., creating pillars, hills and valleys on the silicon wafer using CMOS techniques. The height of these features is carefully controlled by the surface machining CMOS process.

In some examples, a suitable polymer is spin-coated on the silicon wafer at controlled thickness, e.g., about one or two microns below the peak heights. After the polymer film is dried and a protective monolayer is deposited on the film, the film is peeled off with all the holes and shapes on the polymer film. Accordingly, the soft mask is created. Since the master pattern is unchanged, this process can be repeated thousands of times, producing thousands of soft masks with identical patterns.

In certain examples, The soft mask is put or arranged on the engine parts (which can have surface coatings, treatments, or even some simple surface textures) with the help of especially designed jigs to eliminate air bubbles between the mask and the engine part surface. Electrochemical etching is then performed to transfer the pattern onto the engine part surface. The parts are then washed with distilled water three times and dried with gas.

A soft mask (such as 610, 920) of the present disclosure is capable of complying to irregular bumpy surfaces by being soft, and thus is a compliant mask, in contrast to a rigid mask (such as glass) that is hard, rigid, cannot bend, and cannot work on irregular rough surfaces such as engine components. The soft mask (such as 610, 920) can work on irregular rough surfaces such as engine components.

The one-step fabrication process of the present disclosure does not require flat surface, smoothness, or 2 UV exposure steps in clean room conditions.

Large data base of friction reduction mechanisms and what surface features (including size, shape, pitch, depth, and sometimes mixed shapes) is needed to design the textural features to achieve the friction reduction objectives. Then the parts are fabricated and tested in bench tests and rig tests to confirm validity of the design.

In some examples, high precision metrology tools and image measurement to confirm the process produces the desired specifications, then the surface is protected by a polymeric films and vacuum pack the parts for shipment.

The various specialized jigs may be used in fabricating textures on various engine parts to ensure the soft masks are properly attached to the rough irregular-shaped engine parts without trapped air bubbles. When used in manufacturing, these steps can be automated in a clean room environment to avoid dust particles. The process described in the disclosure are mostly carried out in a clean room environment.

This fabrication process is low cost and can be applied to many other applications. Putting or forming precise surface features using this 1-step process can enable control of real contact areas, and enhance or decrease heat transfer. The texture features can contain nano-, micro-scales devices and chemicals (healing agents, repair agents, anti-corrosion agents, rust inhibitors, etc.) buried at different depths to provide additional functionalities.

It is noted that the disclosure refers to certain reagents and materials, such as polymers, PDMS, polymerization catalyst (for mixing with PDMS prepolymer), polyvinyl alcohol, self-assembled long chain organic molecules, olephobic layer, etc. However, other suitable materials and/or reagents can be utilized.

It is noted that the drawings may illustrate, and the description and claims may use geometric or relational terms, such as down, circular, on, in, etc. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

Modifications, additions, or omissions may be made to the systems, apparatuses, and methods described herein without departing from the scope of the disclosure. Moreover, the operations of the systems and apparatuses disclosed herein may be performed by including more, fewer, or other components; and the methods described may include more, fewer, or other steps. Additionally, steps may be performed in any suitable order.

1. A method of forming a surface texture, comprising:
arranging a flexible mask with a pattern over a surface of a component; and
performing electrochemical etching on the surface of the component to form the surface texture on the surface according to the pattern of the flexible mask.

2. The method of claim 1, wherein:
the component include an engine component;
the surface of the component includes a curved surface.

3. The method of claim 1, wherein the surface of the component includes at least one of convex surface or concave surface.

4. The method of claim 1, wherein arranging the flexible mask over the surface of the component includes:
arranging the soft mask over a roller surface of a roller of a transfer apparatus
mounting the component on a holder of the transfer jig;
lifting the component on the holder to be in contact with the soft mask on the roller; and
flipping the soft mask to the surface of the component.

5. The method of claim 4, wherein the roller surface of the roller is coated with a hydrophilic polymeric thin film.

6. The method of claim 4, wherein arranging the flexible mask over the surface of the component further includes removing air bubbles between the soft mask and the surface of the component by using a vacuum.

7. The method of claim 4, wherein arranging the flexible mask over the surface of the component further includes:
placing the transfer apparatus and the component in a housing; and creating a vacuum in the housing to remove air bubbles between the soft mask and the surface of the component.

8. The method of claim 1, wherein the flexible mask includes polydimethylsiloxane (PDMS).

9. The method of claim 1, wherein the pattern of the flexible mask includes a circular dimple pattern.

10. The method of claim 1, wherein performing electrochemical etching on the surface of the component includes:
immersing the surface of the component in an electrochemical bath; applying voltage to etch the surface of the component according to the pattern of the flexible mask.

11. A transfer apparatus, comprising:
a holder configured to hold a component; and
a roller having a roller surface configured to transfer a flexible mask to the component.

12. The transfer apparatus of claim 11, wherein the roller has a cylindrical shape.

13. The transfer apparatus of claim 11, further comprising:
a base; and
one or more support members over the base and being configured to support the roller;
wherein the holder is over the base.

14. The transfer apparatus of claim 11, wherein the holder includes a height-adjustable holder configured to lift the component to be in contact with the soft mask over the roller.

15. The transfer apparatus of claim 11, wherein the roller surface of the roller is coated with a hydrophilic polymeric thin film to reduce adhesion between the roller surface and the flexible mask.

16. The transfer apparatus of claim 11, the flexible mask includes polydimethylsiloxane (PDMS).

17. The transfer apparatus of claim 11, wherein the bearing holder has a concave portion (1241) configured to hold the component.

18. The transfer apparatus of claim 11, wherein the roller has a cylindrical shape.

19. A method of forming a flexible mask, comprising:
etching a wafer with a photoresist pattern to create a first plurality of columns and a second plurality of trenches adjacent the first plurality of columns; filling a polydimethylsiloxane (PDMS) prepolymer and a curing agent in the second plurality of trenches of the wafer by spin coating;
curing the PDMS prepolymer and the curing agent at an elevated temperature to form a flexible mask.

20. The method of claim 19, further comprising:
forming a barrier layer between the wafer and the flexible mask.

21. The method of claim 20, wherein the barrier layer includes a hydrophilic polymeric thin film to reduce adhesion between the wafer and the flexible mask.

22. The method of claim 19, further comprising:
peeling off the flexible mask from the wafer.
